(19) United States
(12) Patent Application Publication
(10) Pub. No.: US 2009/0100759 A1
(43) Pub. Date: Apr. 23, 2009

(54) HINGE DEVICE FOR TAILGATE GLASS

(76) Inventor: Insu Hwang, Gyeonggi-do (KR)

Correspondence Address: MORGAN, LEWIS & BOCKIUS LLP (SF), One Market, Spear Street Tower, Suite 2800, San Francisco, CA, 94105, US

(21) Appl. No.: 11/963,010

(22) Filed: Dec. 21, 2007

(30) Foreign Application Priority Data
Oct. 18, 2007 (KR) 10-2007-0104964

(51) Int. Cl. E06B 3/32

(52) U.S. Cl. 49/381

(57) ABSTRACT

The present invention provides a hinge device capable of adjusting an angle between a flip-up glass and a tailgate, at multiple steps, thereby improving user's convenience. The hinge device for a tailgate glass includes a base hinge, a rotary hinge, a glass hinge, and a turning angle adjusting unit. The base hinge is fixed to a tailgate and has multistage fixing gear teeth. The rotary hinge is connected to base hinge by a connecting pin so as to rotate with respect to the base hinge. The turning angle adjusting unit adjusts a relative moving stroke of glass hinge with respect to rotary hinge and thus selectively changes an engagement position between fixing gear teeth and locking protrusion, thereby adjusting the angle of glass hinge with respect to base hinge at multiple steps.

### CROSS-REFERENCE TO RELATED APPLICATIONS

The present application is based on, and claims priority from, Korean Application Serial Number 10-2007-0104964. tiled on Oct. 18, 2007, the disclosure of which is hereby incorporated by reference herein in its entirety,

### FIELD OF THE INVENTION

The present invention relates to a hinge device for a tailgate glass, and more particularly, to a hinge device capable of adjusting a position angle of a flip-up glass of the tailgate, at multiple steps.

### BACKGROUND OF THE INVENTION

In general, a tailgate that is opened or closed is provided at the rear portion of a sport utility vehicle (SUV) and a flip-up glass 3 is provided on a tailgate 1 as shown in FIG. 1.

As shown in FIG. 2, flip-up glass 3 positioned on an upper portion of the tailgate 1 is opened or closed by the operation of a base hinge 1a and a glass hinge 3a. The base hinge 1a is fixed onto an upper portion of tailgate 1. The glass hinge 3a is hingedly-coupled to the base hinge la and is fixed to an upper portion of the tailgate 1.

In this case, the flip-up glass 3 is provided with gas lifters 5 that maintain flip-up glass 3 opened or closed. A proximate end portion of each of gas lifters 5 is connected to tailgate 1, and a distal end portion thereof is connected to the flip-up glass 3.

However, the angle of the above-mentioned flip-up glass 3 in the related art is limited by the maximum stroke of each of gas lifters 5 when flip-up glass 3 is opened. For this reason, there is a problem in that the open angle of flip-up glass 3 with respect to tailgate 1 cannot be adjusted.

Therefore, when flip-up glass 3 is completely opened, a short user cannot reach a handle 7 provided at the lower portion of flip-up glass 3, which causes user's inconvenience. When the flip-up glass 3 is opened at a location not enough to be open flip-up glass 3, there is also a problem in that flip-up glass 3 is damaged due to external interference.

The information disclosed in this Background of the Invention section is only for enhancement of understanding of the background of the invention and should not be taken as an acknowledgement or any form of suggestion, that this information forms the prior art that is already known to a person skilled in the art.

### SUMMARY OF THE INVENTION

Accordingly, the present invention has been made in an effort to solve the aforementioned problems associated with prior arts, and provides a hinge device capable of adjusting an angle of a flip-up glass, which is pivotally provided to a tailgate so as to open or close the tailgate, at multiple steps, thereby improving user's convenience.

According to an exemplary embodiment of the present invention, a hinge device for a tailgate glass, the hinge device includes a base hinge, a rotary hinge, a glass hinge, and a turning angle adjusting unit. The base hinge is fixed to a tailgate and has multistage fixing gear teeth formed to control the opening/closing position of a flip-up glass. The rotary hinge is connected to the base hinge by a connecting pin so as to rotate with respect to the base hinge. The glass hinge receives the rotary hinge, is provided to move only in one direction, i.e., a longitudinal direction of the rotary hinge, includes a locking protrusion selectively engaged with one fixing gear tooth of the multistage fixing gear teeth, and fixes the flip-up glass. The turning angle adjusting unit adjusts a relative moving stroke of the glass hinge with respect to the rotary hinge and thus selectively changes an engagement position between the fixing gear teeth and the locking protrusion, thereby adjusting the angle of the glass hinge with respect to the base hinge at multiple steps.

According to the embodiment of the present invention, the hinge device can adjust an angle of the flip-up glass, which is pivotally provided to a tailgate so as to open or close the flip-up glass, at multiple steps according to user's request. Therefore, it is possible to expect the improvement of the market quality and user's convenience for a flip-up glass.

Further, since the angle of a flip-up glass can be maintained constant due to the engagement structure of the hinge, parts such as gas lifters do not need to be provided. As a result, it is possible to expect the reduction in manufacturing cost.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view showing a hinge device for a tailgate glass in the related art;

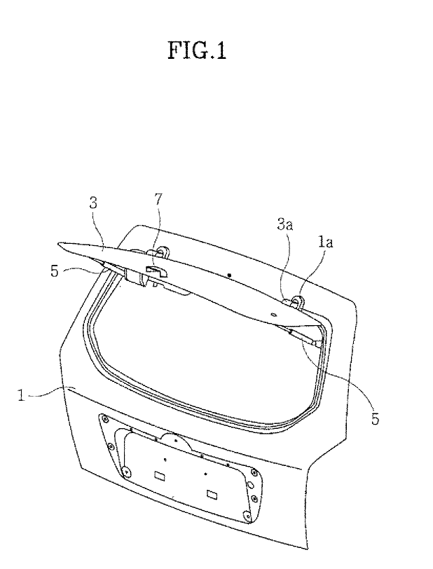

FIG. 2 is an enlarged view of a hinge shown in FIG. 1;

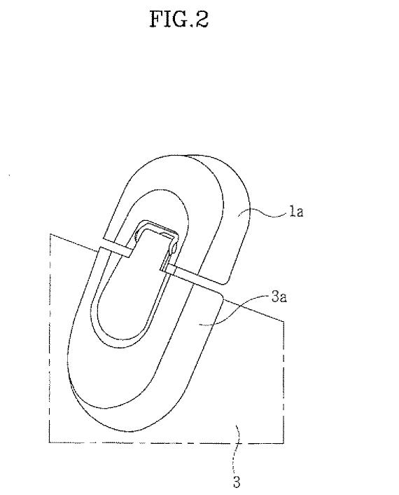

FIG. 3 is a view showing a hinge device for a tailgate glass according to an exemplary embodiment of the present invention;

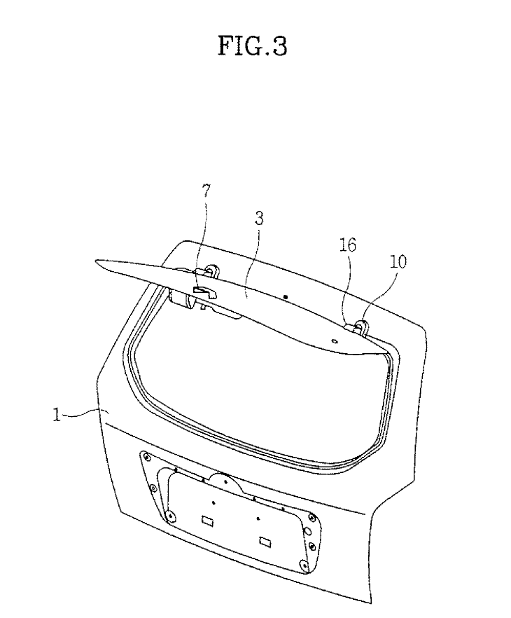

FIG. 4 is a enlarged view of a hinge shown in FIG. 3; and

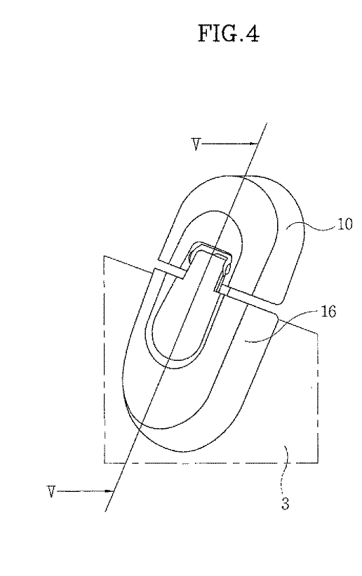

FIG. 5 is a cross-sectional view taken along a line V-V of FIG. 4.

It should be understood that the appended drawings are not necessarily to

scale, presenting a somewhat simplified representation of various preferred features illustrative of the basic principles of the invention. The specific design features of the present invention as disclosed herein, including, for example, specific dimensions, orientations, locations, and shapes will be determined in part, by the particular intended application and use environment.

In the figures, reference numbers refer to the same or equivalent parts of the present invention throughout the several figures of the drawing.

### DETAILED DESCRIPTION OF THE PREFERRED EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

A preferred embodiment of the present invention will be described in detail below with reference to accompanying drawings.

As shown in drawings, a hinge device for a tailgate glass according to an exemplary embodiment of the present invention includes a base hinge 10, a rotary hinge 14, a glass hinge 16, and a turning angle adjusting unit.

The base hinge 10 is fixed to an upper portion of a tailgate 1, and has multistage fixing gear teeth 12 formed to control the opening/closing operation of the flip-up glass 3 that is provided in a tailgate 1.

The rotary hinge 14 is coupled to the base hinge 10 by a connecting pin P so as to rotate the glass hinge 16 with respect to the base hinge 10. For this purpose, the connecting pin P passes through connection portions (not shown) of the rotary hinge 14 and the base hinge 10.

The glass hinge 16 includes a slot 16b, which is elongated in a longitudinal direction of the glass lunge 16. The glass hinge 16 receives complementarily the rotary hinge 14 in the slot 16b as explained later.

While receiving the rotary hinge 14, the glass hinge 16 is provided to move only in one specific direction, i.e., in the longitudinal direction of the glass hinge 16 toward the connecting pin P of the base hinge 10.

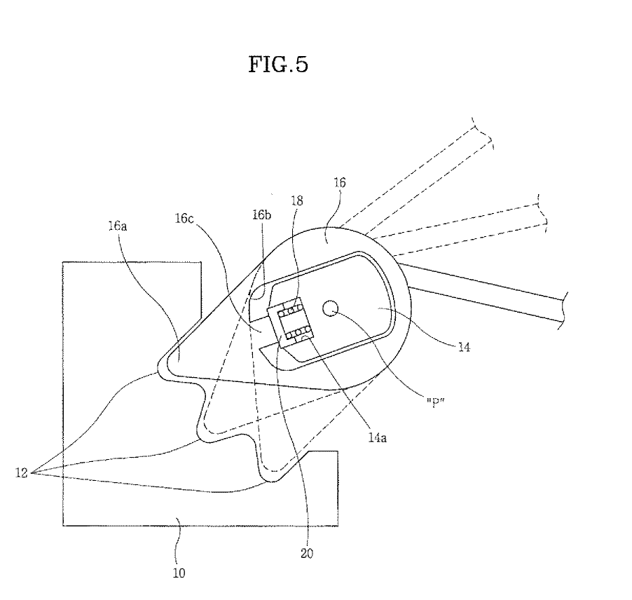

The base hinge 10 includes multistage fixing gear teeth 12 as shown in FIG. 5. In contrast, the glass hinge 16 includes a locking protrusion 16a that is selectively engaged with a root portion of one of multistage fixing gear teeth 12 so as to set an angle of rotary hinge 14 with respect to the multistage fixing gear teeth 12.

In addition, the upper portion of flip-up glass 3 is fixed to and supported by glass hinge 16.

The turning angle adjusting unit adjusts a relative moving stroke of glass hinge 16 with respect to the rotary hinge 14 and thus selectively changes an engagement position between the root portion of multistage fixing gear teeth 12 and the locking protrusion 16a, thereby functioning to adjust the angle of glass hinge 16 with respect to base hinge 10 at multiple steps.

For this purpose, in an exemplary embodiment of the present invention, the slot 16b of the glass hinge 16 has substantially the same level as the rotary hinge 14 and a width larger than the width of rotary hinge 14. The shape of the slot 16b is substantially similar to the shape of the rotary hinge 14 and for example, the shape of the rotary hinge 14 may be rectangular.

Accordingly, the glass hinge 16 is provided to move relative to the rotary hinge 14 only in one direction, i.e., along the longitudinal axis of the rotary hinge 14. Therefore the movement direction of the glass hinge 16 may cross the longitudinal axis of the connecting pin P

Further, a groove 14a is formed on one side of rotary hinge 14 in the turning angle adjusting unit so as to face the multistage fixing gear teeth 12. In this case, an elastic member 18 is received in groove 14a and a protrusion 16c that protrudes so as to press the elastic, member 18 is formed on the inner surface of slot 16b.

Furthermore, a plug 20 is provided between the protrusion 16c and the elastic member 18 in the groove 14a of the rotary hinge 14. A backside of the plug 20 is elastically supported by the elastic member 18 and a front side of the plug 20 faces the protrusion 16e of the glass hinge 16. Accordingly, while the elastic member 18 is pressed by a crest portion or a root portion of the multistage fixing gear teeth 12 through plug 20, the protrusion 16c moves in the groove 14a of the rotary hinge 14.

In another exemplary embodiment of the present invention, a groove 14a and protrusion 16c are positioned at the opposite side with respect to the connecting pin P.

In this ease, an elastic member 18 received in groove 14a may be extended while the locking protrusion 16a is pressed.

In an exemplary embodiment of the present invention, the elastic member 18 may be a spring and the elastic member 18 can be variously embodied by a person of ordinary skill in the art based on the teachings contained herein.

The operation of the hinge device for a tailgate glass according to the embodiment of the present invention will be described in detail below.

In order that the flip-up glass 3 is opened with respect to the tailgate 1, a user catches a handle 7 provided at the lower portion of flip-up glass 3 and lifts the flip-up glass 3.

In this case, the locking protrusion 16a of glass hinge 16 is selectively engaged with multistage fixing gear teeth 12 of the base hinge 10, so that an open or close angle of flip-up glass 3 can be adjusted with respect to the base hinge 10.

That is, the angle of the glass hinge 16 with respect to the base hinge 10 is determined by the engagement position of the locking protrusion 16a of the glass hinge 16 with respect to the multistage fixing gear teeth 12. In this case, while the glass hinge 16 moves in a longitudinal direction along the rotary hinge 14 that is hinge-connected to base hinge 10 by connecting pin P, locking protrusion 16a is disengaged from multistage fixing gear teeth 12.

In other words, when glass hinge 16 moves relative to rotary hinge 14 in a longitudinal direction, protrusion 16c may press or pull the plug 20 and moves in the groove 14a formed in rotary hinge 14. Subsequently, when the angle of glass hinge 16 with respect to base hinge 10 is adjusted and an operation force applied to flip-up glass 3 is then removed, protrusion 16c of glass hinge 16 is pushed or pulled by the restoring force of spring 18 so as to be separated from groove 14a to the outside. For this reason, locking protrusion 16a is engaged with multistage fixing gear teeth 12 again, so that the angle of flip-up glass 3 can be maintained constant

In this case, since the angle of flip-up glass 3 with respect to tailgate 1 can be vary depending on multistage fixing gear teeth 12 formed in base hinge 10, the angle of flip-up glass 3 can be set to various values.

Further, since the angle of glass hinge 16 with respect to base hinge 10 is maintained due to the engagement between multistage fixing gear teeth 12 and locking protrusion 16a of the glass hinge 16 as described above, gas lifters do not need to be used to maintain the angle of flip-up glass 3 unlike in the related art.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents.

What is claimed is:

1. A hinge device for a tailgate glass, the hinge device comprising:
a base hinge that is fixed to a portion of a tailgate and has multistage fixing gear teeth;
a rotary hinge that is connected to the base hinge by a connecting member so as to rotate with respect to the connecting member;
a glass hinge that receives the rotary hinge, is provided to move along a longitudinal direction of the rotary hinge, includes a locking protrusion selectively engaged with a root portion of one fixing gear tooth of the multistage fixing gear teeth, and fixes the flip-up glass; and
a turning angle adjusting unit that adjusts a relative moving stroke of the glass hinge with respect to the rotary hinge and thus selectively changes an engagement position between the multistage fixing gear teeth and the locking protrusion, thereby adjusting an position angle of the glass hinge with respect to the base hinge at multiple steps.

2. The hinge device as defined in claim 1, wherein the connecting member is a connecting pin

3. The hinge device as defined in claim 1, wherein, the glass hinge includes a slot that has substantially the same level as the rotary hinge and a width larger than the width of the rotary hinge.

4. The hinge device as defined in claim 1, wherein the turning angle adjusting unit includes:
a groove formed on one side of the rotary hinge;
an elastic member received in the groove; and
a protrusion that protrudes from the inner surface of the slot toward the groove so as to press or pull the elastic member.

5. The hinge device as defined in claim 4, wherein a plug, of which backside is elastically supported by the elastic member and front side faces the protrusion, is provided in the groove.
